(19) United States
(12) Patent Application Publication
(10) Pub. No.: US 2001/0004398 A1
(43) Pub. Date: Jun. 21, 2001

(54) Connecting device for connecting a sound producing device to an electronic equipment

(76) Inventors: Hajime Omata, Fujiyoshida-shi (JP); Shunichi Watanabe, Fujiyoshida-shi (JP); Atsushi Kuwabara, Fujiyoshida-shi (JP); Yoshizumi Ohta, Fujiyoshida-shi (JP)

Correspondence Address: BIRCH STEWART KOLASCH & BIRCH, PO BOX 747, FALLS CHURCH, VA, 22040-0747, US

(21) Appl. No.: 09/741,051

(22) Filed: Dec. 21, 2000

(30) Foreign Application Priority Data
Dec. 21, 1999 (JP) 11-363525

(51) Int. Cl. H04R 1/02

(52) U.S. Cl. 381/386; 381/388; 381/395; 381/394

(57) ABSTRACT

A connecting device for connecting a sound producing device to an electronic equipment has a connector secured to the sound producing device, and having a pair of elastic contacts and an opening. A slider is provided to be inserted in the connector from the opening, and provided to press the elastic contacts of the connector against terminals of a substrate inserted in the connector from the opening.

### BACKGROUND OF THE INVENTION

The present invention relates to a connecting device for electrically connecting a sound producing device to an electronic equipment such as a portable telephone.

The sound producing device for the portable telephone is mounted in the portable telephone, and a coil of a buzzer or a speaker is connected to a circuit in the telephone.

FIG. 7 shows a conventional device for connecting a sound producing device to an electronic equipment. A manufacturer A manufactures the sound producing device 1 having a pair of leads 2 and a connector comprising a plug 3 and a socket 4. A coil of the sound producing device 1 is connected to a circuit of a substrate 5 of a portable telephone through the leads 2 and the plug 3 and socket 4 by a telephone manufacturer B who bought the device 1.

The sound producing device 1 of FIG. 8 is connected to the circuit of the substrate 5 by a pair of spring plates 6 by the manufacturer B.

The sound producing device 1 shown in FIG. 9 is connected to the circuit on the substrate by a pair of coil springs 7.

In the device 1 of FIG. 7, the number of parts comprising the leads 2, plug 3 and socket 4 is large, and a large number of manufacturing steps are required.

In the device of FIG. 8 or 9, the manufacturer B must solder the spring plates 6 or coil springs 7 to the circuit of the substrate 5.

### SUMMARY OF THE INVENTION

An object of the present invention is to provide a connecting device which may easily connect a sound producing device to an electronic equipment.

According to the present invention, there is provided a connecting device for connecting a sound producing device to an electronic equipment comprising a connector secured to the sound producing device, and having a pair of elastic contacts and an opening, a slider to be inserted in the connector from the opening, and being provided to press the elastic contacts of the connector against terminals of a substrate inserted in the connector from the opening.

Each of the elastic contacts is a cantilever embedded in the connector at a base thereof, and extended in an inserting direction of the slider, and has contacting projection upwardly projected at a front end portion.

The slider has a pressure portion and an introducing portion adjacent to the pressure portion having an upward slant formed on the underside thereof, the introducing portion is provided to form a gap between the elastic contact at a substrate introducing position for introducing the substrate therein.

These and other objects and features of the present invention will become more apparent from the following detailed description with reference to the accompanying drawings.

### BRIEF DESCRIPTION OF DRAWINGS

FIG. 1a is a plan view of a sound producing device having a connecting device of the present invention;

FIG. 1b is a side view of the device;

FIG. 1c is a front view of the device;

FIG. 2 is a plan view showing the underside of the device;

FIGS. 3a and 3b are sectional views taken along a line III of FIG. 1a, respectively;

FIG. 4a is a left side view of a connector;

FIG. 4b is a plan view of the connector;

FIG. 4c is a sectional view taken along a line c-c of FIG. 4b;

FIG. 4d is a front view of the connector;

FIG. 4e is a sectional view taken along a line e-e of FIG. 4d;

FIG. 5a is a plan view of a slider;

FIG. 5b is a sectional view taken along a line b-b of FIG. 5a;

FIG. 5c is a sectional view taken along a line c-c of FIG. 5a;

FIG. 5d is a front view of the slider;

FIGS. 6a to 6c are sectional plan views showing the inserting operation of the slider; and

FIGS. 7 to 9 show conventional sound producing devices.

### DETAILED DESCRIPTION OF THE PREFERRED EMBODIMENT

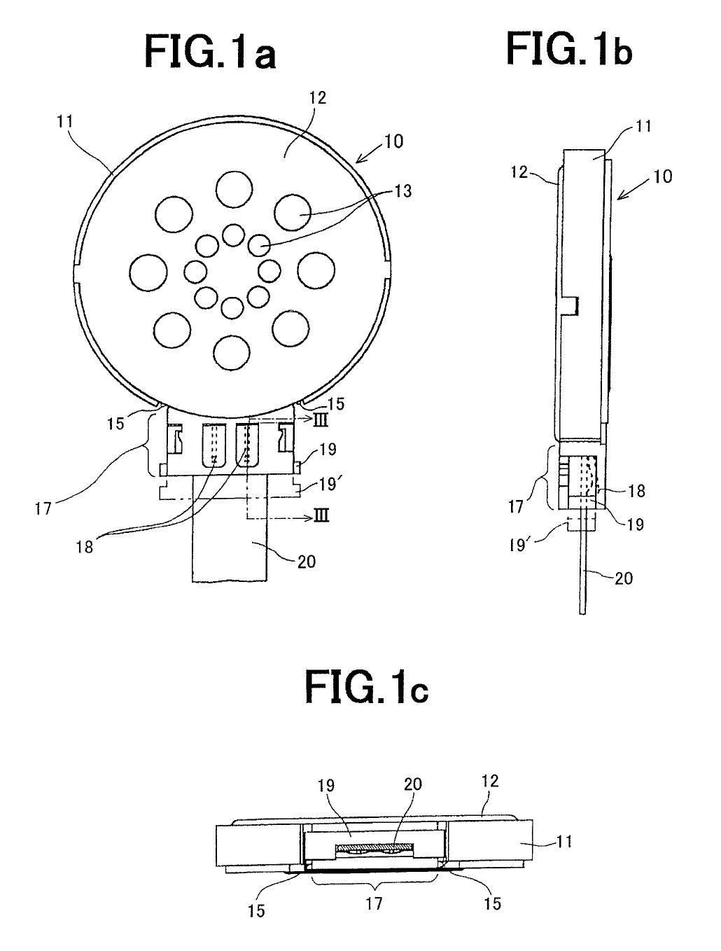

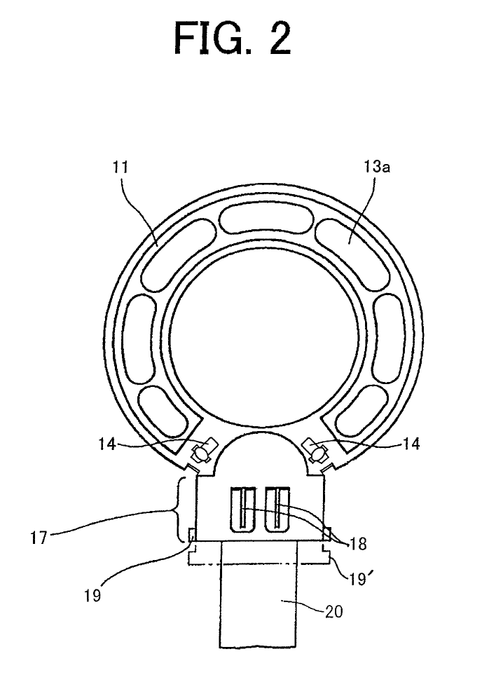

Referring to FIGS. 1a to 1e and FIG. 2, a sound producing device 10 has a case 11 and a cover 12 which are made of plastic. The cover 12 has a plurality of sound discharge holes 13, and the underside of the case 11 also has a plurality of sound discharge hole 13a as shown in FIG. 2.

A connector 17 according to the present invention is integrated with the case 11 at the molding of the case 11.

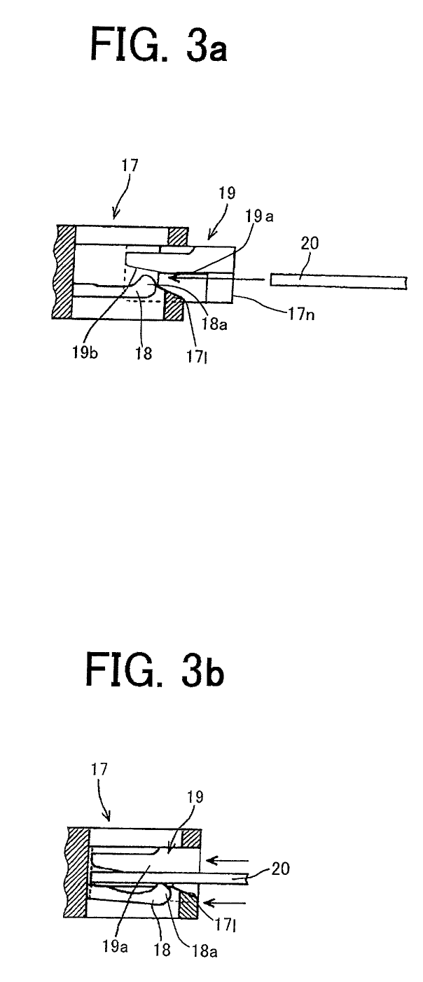

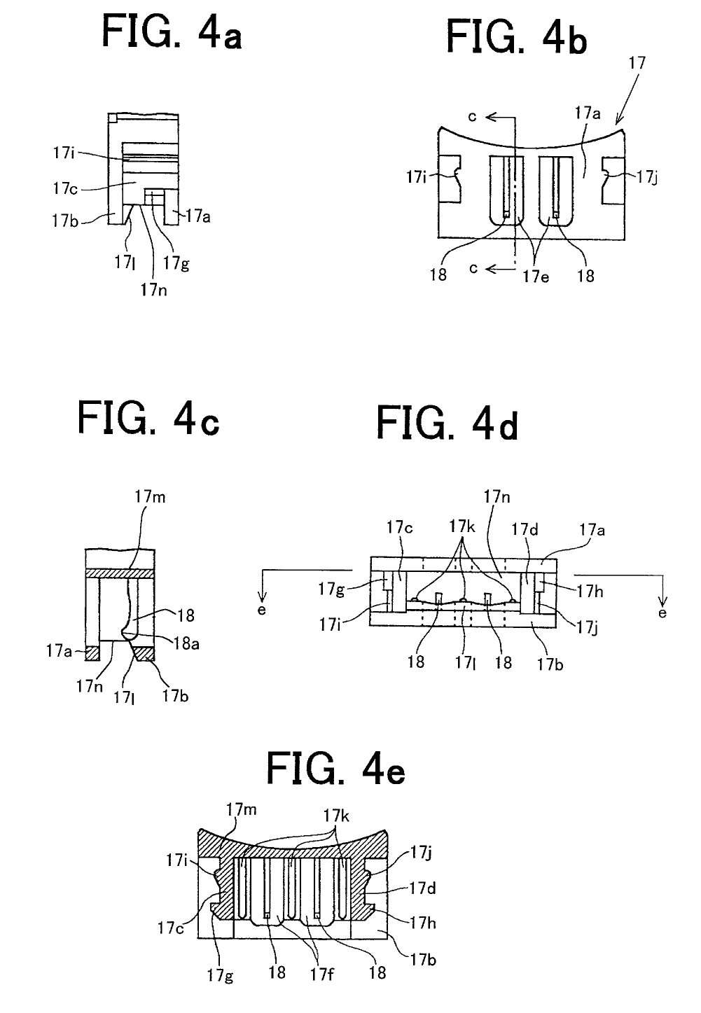

Referring to FIGS. 3a through 4e, the connector 17 has a box shape comprising an upper plate 17a, lower plate 17b, side plates 17c, 17d and rear plate 17m. In the front of the connector 17, an insertion opening 17n is formed. The upper plate 17a has a pair of windows 17e, and the lower plate 17b has a pair of windows 17f. A pair of cantilever elastic contacts 18 made of elastic metal are embedded in the rear plate 17m at the molding of the connector 17 and appear in the windows 17e. Each of the elastic contacts 18 has a contacting projection 18a upwardly projected at a front end portion and extends in an insertion direction of a slider 19 (FIG. 3).

On the outer walls of the side plates 17c and 17d, there is formed hooks 17g and 17h, and rib projections 17i and 17j, respectively. Each of the hooks and rib projections are arranged in the slider insertion direction. As shown in FIG. 4a, each of the hooks 17g and 17h is positioned at a position in an upper half location. Each of the rib projections 17i and 17j is elongated a whole height of the side plate 17c (17d).

Referring to FIGS. 4d and 4e, three guide ribs 17k are provided on the lower plate 4b, extending in the slider insertion direction for guiding a flexible substrate 20 (FIG. 3). As shown in FIGS. 4a and 4c, there is formed a slant 17l on the lower plate 17b at the opening 17n for guiding the insertion of the flexible substrate 20.

Referring to FIG. 2, on the underside of the case 11, a pair of terminals 14 are embedded in the case and connected to ends of a coil of a buzzer provided in the case 11. Each of the elastic contacts 18 and the corresponding terminal 14 are formed from a metal plate including intermediate lead so as to be connected through the intermediate lead.

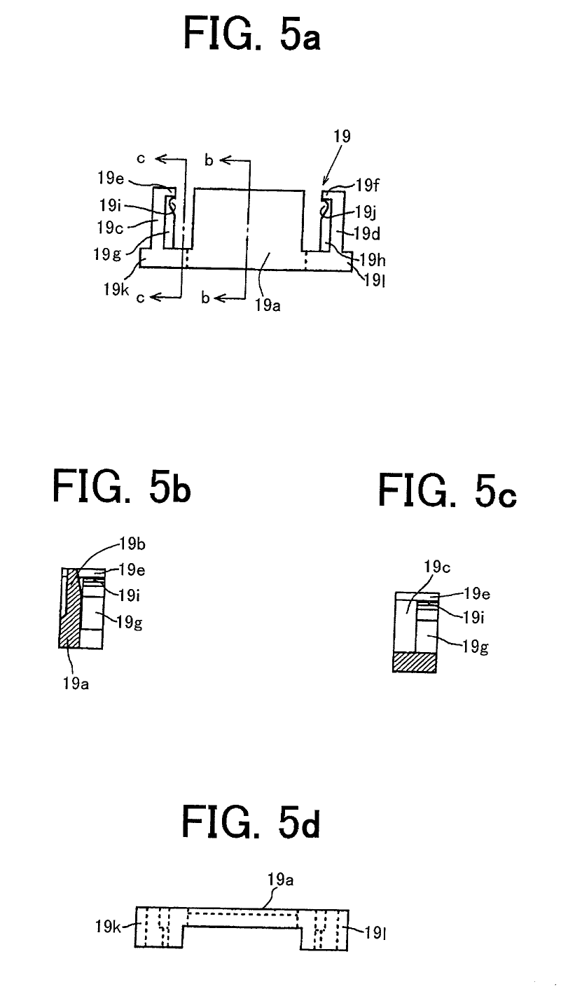

Referring to FIGS. 5a to 5d the slider 19 comprises a pressure portion 19a, an introducing portion 19b, adjacent the pressure portion 19a having an upward slant formed on the underside thereof, and a pair of side plates 19c and 19d confronting the opposite sides of the pressure portion 19a.

As shown in FIG. 5b, the pressure portion 19a is positioned in an upper half range. On inside walls of the side plates 19c and 19d, hooks 19e and 19f, ribs 19g and 19h are extending from the hooks are formed. These portions 19e, 19f, 19g and 19h are positioned in a lower half range as shown in FIGS. 5b, 5c. On both sides of the base portion of the slider 19, projections 19k and 19l are provided, outwardly projecting as a pair of knobs for extracting the slider 19 from the connector 17.

The connector 17 and the slider 19 are supplied to a portable telephone manufacturer. The substrate 20 is inserted in the connector 17 by the manufacturer.

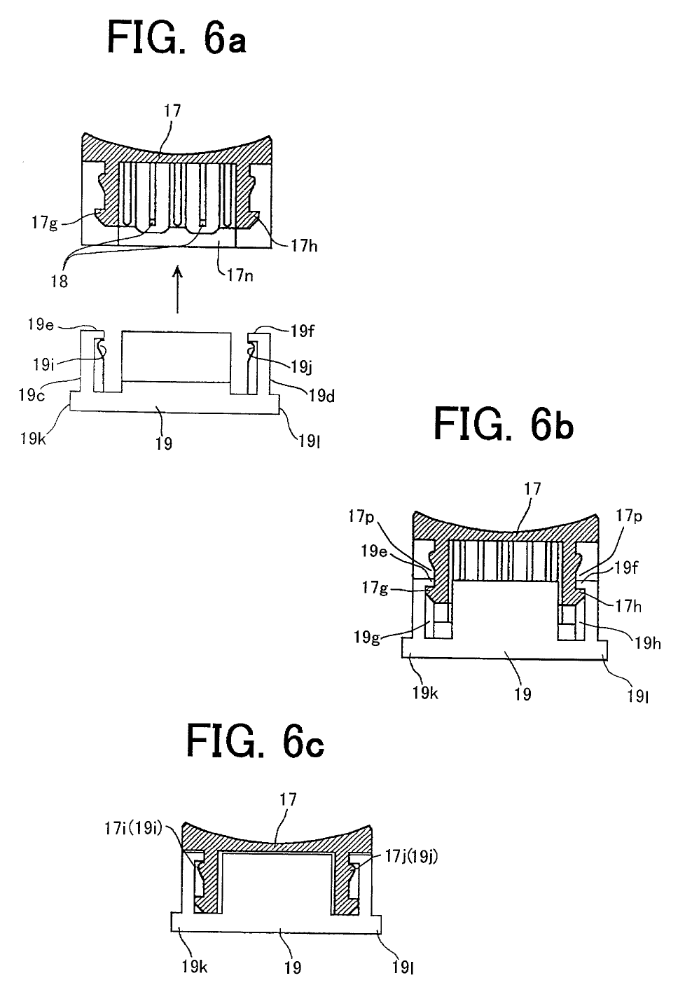

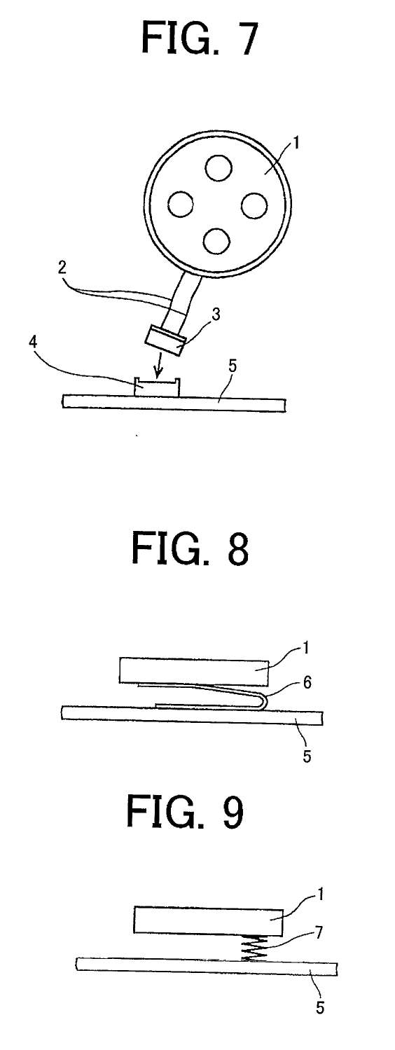

Referring to FIGS. 6a through 6e showing the inserting operation of the slider 19, the slider 19 is inserted in the connector 17 from the opening 17n. At the hooks 17g and 17h, the side plates 19c and 19d are expanded by the engagement of the hooks 19e and 19f, so that the hooks 19e and 19f of the slider 19 get over the hooks 17g and 17h and enter substrate introducing positions 17p.

The inserting of the slider 19 is stopped at the substrate introducing position 17p shown in FIGS. 3a and 6b where a gap is formed between the introducing portion 19b and the contacting projection 18a as shown in FIG. 3a.

Thereafter, the flexible substrate 20 is inserted in the connector 17 from the opening 17n as shown in FIG. 3b. At that time, the flexible substrate 20 is guided by the slant 17l and guide ribs 17k. The substrate passes through the gap between the introducing portion 19b and the contacting projection 18a. As shown in FIG. 3b, the substrate 20 and the slider 19 are inserted to an innermost position of the connector 17, while the hooks 19e and 19f of the slider 19 get over the rib projections 17i and 17j. At the innermost position, the pressure portion 19a of the slider 19 presses the substrate 20 to the elastic contacts 18. Consequently, the connecting projections 18a of the elastic contacts 18 are contacted with terminals on the flexible substrate 20. Thus, the sound producing device 10 is connected to the flexible substrate 20. At the innermost position, the hooks 19e and 19f of the slider 19 engage with outside of the rib projections 17i and 17j, thereby the slider is secured to the connector.

In order to remove the flexible substrate 20, if the slider 19 is pulled out from the position of FIGS. 3b and 6c to the position of FIGS. 3a and 6b, the substrate can be removed. At that time, since the hooks 19e and 19f engage with the hooks 17g and 17b, the slider 19 is not removed.

In accordance with the present invention, since the substrate is connected to the sound producing device by inserting the substrate in the connector, the connecting operation is very easy.

While the invention has been described in conjunction with preferred specific embodiment thereof, it will be understood that this description is intended to illustrate and not limit the scope of the invention, which is defined by the following claims.

What is claimed is:

1. A connecting device for connecting a sound producing device to an electronic equipment comprising:
a connector secured to a case of the sound producing device, and
having a pair of elastic contacts and an opening;
a slider to be inserted in the connector from the opening, and being provided to press the elastic contacts of the connector against terminals of a substrate inserted in the connector from the opening.

2. The device according to claim 1 wherein each of the elastic contacts is a cantilever embedded in the connector at a base thereof, and extended in an inserting direction of the slider.

3. The device according to claim 1 wherein each of the elastic contacts has a contacting projection upwardly projected at a front end portion.

4. The device according to claim 1 wherein the slider has a pressure portion and an introducing portion adjacent the pressure portion and having an upward slant formed on the underside thereof, the introducing portion is provided to form a gap between the upward slant and the elastic contact at a substrate introducing position for introducing the substrate therein.

5. The device according to claim 1 wherein the connector has a pair of side plates, and the slider has a pair of side plates to be slidably engaged with outside walls of the side plates of the connector, the connector has a pair of rib projections on the outside walls of the side plate, and the slider has a pair of hooks which are engaged with the rib projections of the connector at an innermost position so as to secure the slider on the connector.

6. The device according to claim 1 wherein the case of the sound producing device and the connector are made of plastic, and are integrally molded.
